(19) United States
(12) Patent Application Publication
(10) Pub. No.: US 2004/0085755 A1
(43) Pub. Date: May 6, 2004

(54) Illuminated doorknob

(76) Inventor: Karen Denise Dupont, Phoenix, AZ (US)

Correspondence Address: Karen Denise Dupont, 409 W. Renee Dr., PHOENIX, AZ, 85027, US

(21) Appl. No.: 10/213,727

(22) Filed: Nov. 5, 2002

(51) Int. Cl. E05B 17/10

(52) U.S. Cl. 362/100; 362/186; 362/501

(57) ABSTRACT

A doorknob having a graspable knob portion that includes a graspable knob portion having a power source, an illumination source, and a controller for controlling the flow of power between the illumination source provided therein; the power source being selected from various power source types including nickel cadmium batteries, regular batteries, solar panels for charging rechargeable batteries, etc.; the control circuitry including on/off switches, dimmer on/off switches, light sensing circuitry with relays, etc.; the light source including piezo crystals with charging circuits, LEDs, lasers, fiber optics, etc.

### TECHNICAL FIELD

The present invention relates to doorknobs and more particularly to an illuminated doorknob including a graspable knob portion having a power source, an illumination source, and a controller for controlling the flow of power between the illumination source provided therein; the power source being selected from various power source types including nickel cadmium batteries, regular batteries, solar panels for charging rechargeable batteries, etc.; the control circuitry including on/off switches, dimmer on/off switches, light sensing circuitry with relays, etc.; the light source including piezo crystals with charging circuits, LEDs, lasers, fiber optics, etc.

### BACKGROUND ART

It is often difficult for individuals to find doorknobs and the like in the dark. This is particularly true when in unfamiliar surroundings. It would be desirable, therefore, to have a doorknob that included an illumination source such that the doorknob would emit a low level of light that could be seen easily in a darkened room but which was sufficiently dim to not interfere with sleeping or the like.

### GENERAL SUMMARY DISCUSSION OF INVENTION

It is thus an object of the invention to provide a doorknob having a graspable knob portion that includes a graspable knob portion having a power source, an illumination source, and a controller for controlling the flow of power between the illumination source provided therein; the power source being selected from various power source types including nickel cadmium batteries, regular batteries, solar panels for charging rechargeable batteries, etc.; the control circuitry including on/off switches, dimmer on/off switches, light sensing circuitry with relays, etc.; the light source including piezo crystals with charging circuits, LEDs, lasers, fiber optics, etc.

Accordingly, a doorknob having a graspable knob portion is provided. The doorknob having a graspable knob portion includes a graspable knob portion having a power source, an illumination source, and a controller for controlling the flow of power between the illumination source provided therein; the power source being selected from various power source types including nickel cadmium batteries, regular batteries, solar panels for charging rechargeable batteries, etc.; the control circuitry including on/off switches, dimmer on/off switches, light sensing circuitry with relays, etc.; the light source including piezo crystals with charging circuits, LEDs, lasers, fiber optics, etc.

### BRIEF DESCRIPTION OF DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a perspective view of an exemplary embodiment of the doorknob having a graspable knob portion having an on/off switch provided on a shank portion of the doorknob.

FIG. 2 is a second exemplary embodiment of the doorknob having a graspable knob portion of the present invention.

FIG. 3 is a cross sectional view of the doorknob having a graspable knob portion showing a pair of light bulbs positioned within the translucent knob material and the metal contacts that are activated to supply power to the bulbs from the batteries.

### EXEMPLARY MODE FOR CARRYING OUT THE INVENTION

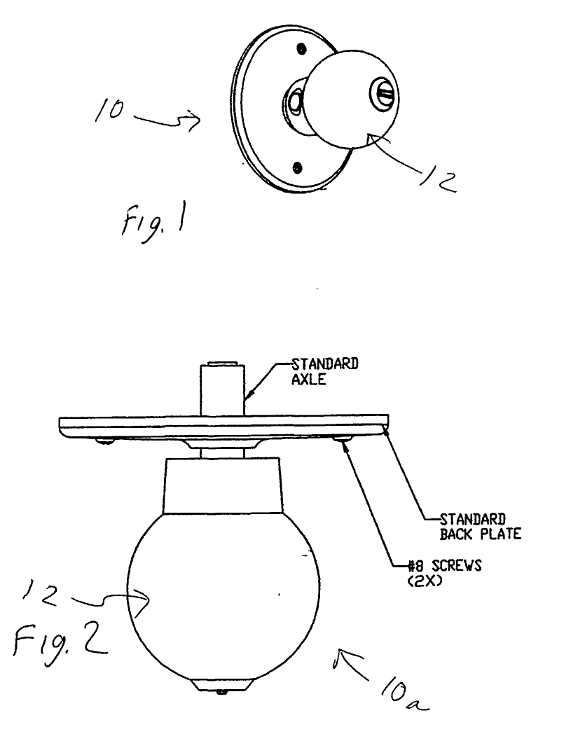

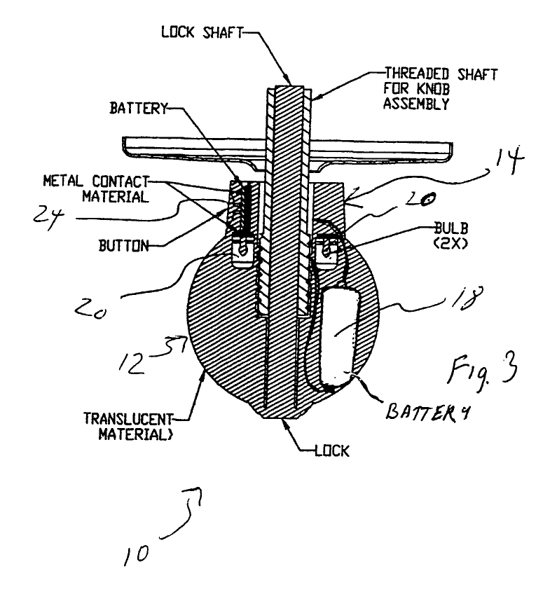

FIGS. 1-3 show various aspects of an exemplary embodiment of the doorknob having a graspable knob portion of the present invention generally designated 10. Doorknob 10 has a graspable knob portion, generally designated 12, that is positioned at the end of shank portion, generally designated 14, that includes on/off switch 16. Graspable knob portion 12 has a battery 18 as its power source, two light bulbs 20 as the illumination source, and a momentary contact switch 24 located on the shank portion 14 for controlling the flow of power between the light bulbs 20 and battery 18.

Knob portion 12 is formed of translucent plastic such that, when light bulbs 20 are illuminated, knob portion 12 emits a soft glow.

It can be seen from the preceding description that a doorknob having a graspable knob portion has been provided.

It is noted that the embodiment of the doorknob having a graspable knob portion described herein in detail for exemplary purposes is of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

What I claim as my invention is:

1). Illuminated door knob with keyhole
